(19) United States
(12) Patent Application Publication
(10) Pub. No.: US 2013/0249202 A1
(43) Pub. Date: Sep. 26, 2013

(54) MULTI-MEDIA DEVICE HOLDER FOR STROLLER

(71) Applicants: Bryan T. White, Fremont, CA (US); Joseph Hei, Palo Alto, CA (US); Mariel Lanas, (US); Colter P. Leys, Salt Lake City, UT (US)

(72) Inventors: Bryan T. White, Fremont, CA (US); Joseph Hei, Palo Alto, CA (US); Mariel Lanas, (US); Colter P. Leys, Salt Lake City, UT (US)

(21) Appl. No.: 13/619,802

(22) Filed: Sep. 14, 2012

Related U.S. Application Data
(60) Provisional application No. 61/534,804, filed on Sep. 14, 2011.

(51) Int. Cl. B60R 11/02

(52) U.S. Cl. CPC B60R 11/0229
USPC 280/769

(57) ABSTRACT

A multimedia device pouch is provided for attaching to a stroller or other ambulatory vehicle and holding a multimedia device in multiple viewing orientations. The pouch includes fasteners for attaching the pouch to a stroller and a pocket to secure a multimedia device. The pocket includes a window configured such that a user may interact with and view the device through the window while keeping the device secured. The pouch may also include additional fabric and/or fasteners configured to angle the pocket for viewing the multimedia device at various viewing angles. A stroller is also provided with a multimedia device pouch attached to the stroller handle, the stroller handle configured to pivot between multiple operating positions, with the viewing angle of the multimedia device in the pouch changing with the multiple operating positions to provide various viewing alternatives to both stroller passengers and those pushing the stroller.

### CROSS-REFERENCE TO RELATED APPLICATIONS

This application claims priority to U.S. Provisional Application No. 61/534,804 filed with the U.S. Patent and Trademark Office on Sep. 14, 2011, the entire contents of which are hereby incorporated by reference for all purposes.

### BACKGROUND

1. Field

The present invention relates generally to the field of digital multimedia device holders, and more particularly, to digital multimedia device holders adapted for attaching to a stroller or other ambulatory vehicle.

2. Related Art

Digital multimedia devices are increasing in both popularity and functionality. For example, a mother walking her child in a stroller may use her digital device to access maps, listen to music, or search for a nearby kid-friendly restaurant for lunch. The utility of such devices, however, can be limited by their fragility, and outdoor use can lead to severe, irreparable damage to the devices. For instance, users walking around with their multimedia device may trip and fall, losing hold of the device, and causing the device's screen to shatter or damaging internal components beyond repair.

Parents with small children are also finding ways to use their multimedia devices to keep children entertained during travel. For example, a parent running with a child in a stroller may use a digital media player to keep the child entertained for extended durations. This advanced utility, however, is again limited by the fragility of the devices, and children using the devices may be more prone to cause damage. Some devices may also be too heavy or bulky for children to use effectively for extended duration, thereby limiting the device's utility and the parent's workout duration.

There is accordingly a need for a protective pouch or device holder that allows parents to safely use their devices outdoors when pushing a stroller. There is further a need for a protective pouch or holder that allows parents to entertain their children traveling in strollers with multimedia devices without subjecting the devices to excess danger. There is also a need for a protective pouch or holder that secures or supports digital devices for extended durations to limit fatigue from holding such devices.

### BRIEF SUMMARY

In one embodiment, a stroller is disclosed that may include a child seat, a handle for pushing the stroller, and a multimedia device pouch attached to the stroller handle. The multimedia device pouch may include one or more fasteners for attaching the pouch to the stroller handle and a pocket configured to at least partially secure or support a multimedia device. The pocket may include a window through which the device may be viewed. The multimedia device pouch may also include one or more of a zipper, a snap, Velcro, a magnet, elastic, a screw, extra fabric, or a fastener configured to angle the pocket for viewing the multimedia device at two or more viewing angles. The stroller handle may also be configured to pivot between multiple operating positions, with the viewing angle of the multimedia device in the pouch changing with the multiple operating positions to provide various viewing alternatives to both stroller passengers and those pushing the stroller.

In one embodiment, a protective pouch or holder for a digital multimedia device is disclosed. The pouch may include one or more fasteners for attaching the pouch to a stroller or similar ambulatory vehicle. The pouch may also include a pocket configured to secure or support a multimedia device. The pocket may include a window through which the device may be viewed. The multimedia device pouch may also include one or more of a zipper, a snap, Velcro, a magnet, elastic, a screw, extra fabric, or a fastener configured to angle the pocket for viewing the multimedia device at two or more viewing angles.

### DESCRIPTION OF THE FIGURES

FIG. 1 illustrates the viewing side of an exemplary multimedia device pouch.

FIG. 2 illustrates the rear or non-viewing side of an exemplary multimedia device pouch.

FIG. 3 illustrates an exemplary multimedia device pouch attached to a stroller handle.

FIG. 4 illustrates a two-seated stroller with an exemplary multimedia device pouch attached to the stroller handle.

FIG. 5 illustrates a stroller with an exemplary multimedia device pouch attached to the stroller handle and configured in a downward-facing orientation for viewing by a child in a horizontal or reclined position in a first stroller seat.

FIG. 6 illustrates a stroller with an exemplary multimedia device pouch attached to the stroller handle and configured in a horizontal-facing orientation for viewing by a child in an upright position in a second stroller seat.

FIG. 7 illustrates a stroller with an exemplary multimedia device pouch attached to the stroller handle and configured in an upward-facing orientation for viewing by a parent pushing the stroller.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

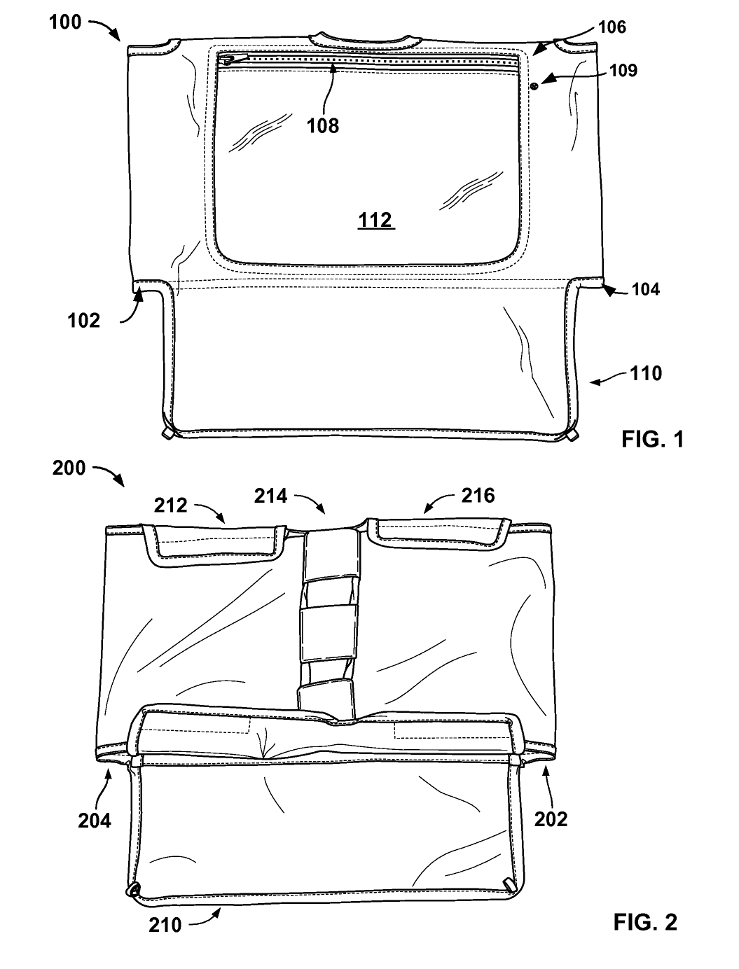

The various embodiments of the present invention are directed to a protective pouch or holder for digital multimedia devices that may be secured to a stroller or similar ambulatory vehicle and used while in transit, while also protecting the devices from dangers inherent in the outdoors, especially while in transit. FIG. 1 illustrates the viewing side of exemplary fabric multimedia device pouch 100 (also referred to herein as a sleeve or holder). Pouch 100 may include any of a variety of fabrics sewn such that it integrates with the handlebars of a stroller or other ambulatory vehicles with handlebars. In one embodiment, pouch 100 may include lightweight, breathable fabrics. In another embodiment, pouch 100 may include durable fabrics, plastics, vinyl, or any combination that, in some embodiments, may repel water or provide an air-tight enclosure. Pouch 100 may protect the device while allowing for interaction with the device even while it is completely enclosed. Pouch 100 may also allow for both a parent pushing a stroller and one or more children sitting in the stroller to view the device.

Pouch 100 may include one or more of fasteners 102 and 104 configured to attach to the sides of a U-shaped handlebar, between two handles of a stroller, between two elements of a stroller frame, along a single frame element, or in a variety of other configurations. In one embodiment, fasteners 102 and 104 may include Velcro to attach the pouch to the handlebar of a stroller. Fasteners 102 and 104 may also include fabric sewn in place to part of a stroller. In yet another embodiment, pouch 100 may be appropriately sized and configured such that fasteners 102 and 104 include material that fits tightly on the handlebar of the stroller without any additional fastening means. As such, pouch 100 in various embodiments may be removable, semi-permanently fixed, or permanently fixed to the stroller. In some embodiments, fasteners 102 and 104 may include fabrics, screws, snaps, zippers, ties, elastic materials, and a variety of other fasteners and fastener combinations to attach pouch 100 to a variety of structural elements of a stroller.

Pouch 100 may also include pocket 106 configured to hold a digital multimedia device. Pocket 106 may include any of a variety of materials or combinations of materials, configured such that a user can view a digital multimedia device through at least one side of the pocket, and in some embodiments, such that a user can interact with the device through at least one side of the pocket. In one embodiment, pocket 106 may include a window or opening 112 on one side of pocket 106 allowing a user to interact directly with a device through the window or opening. In another embodiment, pocket 106 may include clear screen or window 112 on at least one side, comprising material that protects the secured device while allowing for display of the screen of the digital multimedia device through screen or window 112 to the exterior of the pouch.

Screen or window 112 may be made of a variety of different materials and may have a variety of different characteristics for a different user experience. In some instances, secured devices may have pressure- or touch-sensitive screens, touch-sensitive buttons, traditional buttons, or the like, and window 112 may include material configured to allow these controls to function normally through the material or through openings in the material. In one embodiment, window 112 may include polyvinyl chloride (PVC) or ethylene vinyl acetate (EVA) and be clear and flexible to allow users to activate buttons or switches through pocket window 112, or to interact with touch-sensitive screens on some devices. In other instances, secured devices may also have capacitive-touch screens in addition to one or more buttons, and window 112 may include material configured to a particular thickness and composition so as to maintain the capacitive-touch functionality through window 112 of devices with capacitive-touch screens while also maintaining button functionality through window 112. In one embodiment, window 112 may include polycarbonate (PC) or polyethylene terephthalate (PET) and be clear and rigid. One of skill in the art would recognize that there are a variety of materials and material properties that could be used for window 112 to provide a different user experience. As mentioned above, window 112 may also be an opening in one side of pocket 106 allowing direct access to the secured device. Importantly, because the device can be used through window 112, the device may be secured, supported, or even completely enclosed and protected without losing the beneficial functionality of the multimedia device. In some embodiments, window 112 may not be completely clear, but may include a tint or other modification that enhances the ease of viewing for users of particular devices or restricts viewing to protect sensitive information.

Pocket 106 may also be formed from a single material to secure or support the multimedia device by one material on all sides. In another embodiment, pocket 106 may have window 112 on one side as described above, and a different material, such as fabric, on the non-viewing side. Pocket 106 may also secure or support the device in the pocket with closing mechanism 108, which may be a zipper as shown in FIG. 1. Closing mechanism 108 may also include any of a variety of other fasteners or seals such as magnets, Velcro, snaps, elastics, screws, or other fasteners to hold a device securely within pocket 106.

Pouch 100 may be configured to serve as a sunshade for a child traveling in the stroller. For example, pouch 100 may be attachable to the stroller handlebar such that it provides shade to a child below traveling in a seat. In another embodiment, pouch 100 may be attachable to any other element of a stroller to provide shade at the necessary angle for a child traveling in the stroller. Pouch 100—whether a device is secured or not, and whether the position provides viewing and interacting access or not—may thus be positioned to serve as a sunshade for a child traveling in the stroller. To better protect the pouch and any devices therein from the sun and other elements, pouch 100 may include material that is sun resistant or that may be treated to prevent damage from the sun's rays and other elements. In one embodiment, only one side of pouch 100 may be made of a sun-resistant material or treated to prevent damage from the sun's rays and other elements.

Pouch 100 may also include sunshade 110 to provide extra sun protection for stroller passengers beyond the proportions of pocket 106. In one embodiment, sunshade 110 may include additional fabric that is rigid and fixed in place, and that extends beyond pocket 106. In another embodiment, sunshade 110 may include flexible fabric that can be extended and fixed in place to a stroller element or other object by a user when needed, or retracted and stored when unwanted by folding or rolling the material for storage. Sunshade 110 may also include stretchable fabric that can be stretched and secured to provide shade, or released and retracted back to the pouch when not needed. Pouch 100 may also include a separate pocket or storage compartment for additional sunshade fabric.

Examples of multimedia devices that may be secured within pocket 106 of pouch 100 include smartphones, tablet computers, and touch-screen music players. Other devices may also be protected and/or usable within the pouch including media players, traditional cellular phones, portable DVD players, netbooks, laptop computers, and the like. In some embodiments, additional or secondary pockets may be provided for added utility. In one embodiment, pouch 100 may include an additional or secondary pocket opposite pocket 106 for carrying a variety of items. In other embodiments, one or more small pockets may be added in addition to device pocket 106 for other items including keys, snacks, headphones, chargers, wallets, speakers, device accessories, and the like. Additionally, other large pockets may also be added for carrying larger items. Additional pockets may comprise any of the materials and fasteners described above. For example, one or more additional or secondary pockets may include Velcro, a zipper, or a snap to secure stored items.

Pouch 100 and/or pocket 106 may also include one or more holes, channels, or openings for routing wires, such as hole 109 illustrated in FIG. 1. In some embodiments, pocket 106 and/or pouch 100 may include hole 109 configured to route one or more headphone wires from a device secured within pocket 106 out to a user or to speakers. Hole 109 may be configured to prevent water, dust, or other debris from entering through the hole while allowing for headphone wires or other cables to be routed out of the pocket. In some embodiments, hole 109 may be routed through pocket 106 material, pouch 100 material, or window 112. In one embodiment, pouch 100 and/or pocket 106 may include one or more holes or channels routed between pocket 106 and additional pockets, which may be configured to hold speakers or other device accessories. Thus, a variety of combinations of pockets and holes or channels may be configured for a variety of uses.

The various embodiments may be configured to attach to a stroller in a variety of positions for a variety of different applications. In one embodiment, pouch 100 may be attachable to stroller handles such that the multimedia device screen in pocket 106 faces upward; that is, the device's screen is oriented upward and viewable through window 112. In this orientation, the parent pushing the stroller may easily view the screen of the device and interact with the buttons or touch-screen through window 112 of pouch 100. For example, the parent could be using a map application on the device while strolling and easily follow on-screen directions as well as input additional instructions into the device through window 112.

Pouch 100 may also be attachable to the stroller to orient the device for viewing by a child sitting in a stroller seat. This may be accomplished by pivoting the stroller handlebar to which the pouch is attached or by reorienting pocket 106 by means such as zippers and extra folds of fabric or material.

Other arrangements may be contemplated to allow configurability of pouch 100 for viewing and interacting with the device in a variety of positions. For example, pouch 100 may also be configured to attach to a variety of different structural elements on a stroller to accomplish a variety of different viewing and interacting arrangements. In some embodiments, reorienting pouch 100 for different viewing and interacting positions may only require loosening a zipper or unbuttoning one or more buttons or snaps, allowing the viewing side of pouch 100 to rotate to a different angle. One or more viewing positions may also be defined and means provided for orienting and securing pouch 100 in a variety of positions: for example, a variety of angles may be defined and one or more snaps, zippers, or other fastening means provided at each of the variety of angles to secure pouch 100 in a particular orientation for use (i.e., for parental viewing at one angle, parental viewing at a different angle, child viewing at one angle, child viewing at a different angle, etc.). The various orientations may accommodate different parental heights as well as different ages and sizes of children. In some embodiments, pouch 100 may be configured to be oriented at different angles to correspond to the type or orientation of child seat in a stroller (i.e., forward-facing, upward-facing, backward-facing, etc.). In some embodiments, pouch 100 may include additional fabric configured like an accordion and any of the fasteners discussed above such that either side of pouch 100 may be angled and secured as desired.

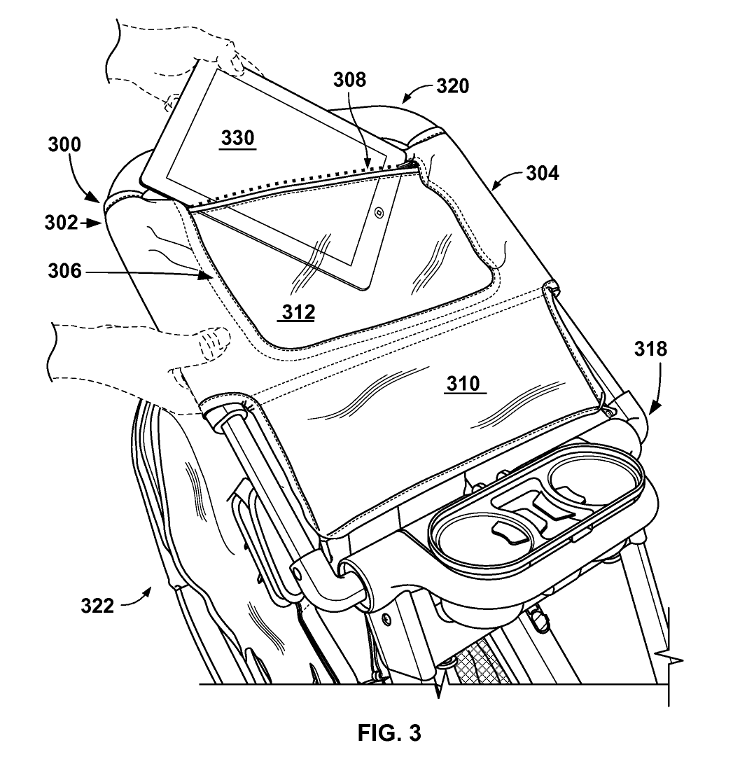

FIG. 2 illustrates the rear or non-viewing side of exemplary multimedia device pouch 200. Pouch 200 may include one or more fasteners 202 and 204 configured to attach to the sides of a U-shaped handlebar, between two handles of a stroller, between two elements of a stroller frame, along a single frame element, or in a variety of other configurations. Fasteners 202 and 204 may include fabrics, screws, snaps, zippers, ties, elastic materials, and a variety of other fasteners and fastener combinations to attach pouch 200 to a variety of structural elements of a stroller. In one embodiment, fasteners 202 and 204 may include Velcro and fabric configured to wrap around and secure to tubular frame or handle elements on a stroller.

Pouch 200 may also include sunshade 210 providing additional material to protect a child traveling below in a stroller from the sun. In one embodiment, sunshade 210 may be attached to pouch 200 by Velcro or any other fastener, and also detachable from the main portion of pouch 200 when not needed. In another embodiment, pouch 200 may include a storage compartment or pocket in which sunshade 210—whether detachable or not—may be stored when not in use.

Pouch 200 may also include additional fasteners, materials, and/or secondary pockets 212, 214, and/or 216 that may be configured to provide alternative methods of attaching pouch 200 to a stroller or other ambulatory vehicle, to provide alternative viewing orientations, or to provide secondary pockets as mentioned above. In one embodiment, fasteners 212 and 216 may be configured to attach to a common stroller frame element, thereby providing an alternative attachment method and a different viewing orientation than fasteners 202 and 204. In another embodiment, fasteners and materials 212, 214, and 216 may be configured to provide a variety of viewing orientations by angling the multimedia device within pouch 200, and securing the pouch at different viewing angles. Fasteners and materials 214 alone may also be configured to orient the multimedia device within pouch 200 at preconfigured angles by, for example, providing several snaps at different positions along an axis or a length of Velcro along an axis for a user-selectable orientation. One of skill in the art would recognize that there are a variety of options using additional folds of fabric, pockets, and additional fasteners like 212, 214, and 216 that would provide a user with numerous orientations for viewing and/or interacting with a multimedia device within pouch 200. In addition, fabric and fasteners 212, 214, and 216 may comprise secondary pockets to provide additional storage as discussed above.

FIG. 3 illustrates exemplary multimedia device pouch 300 attached to stroller 318. As illustrated, pouch 300 may be attached to the sides of U-shaped stroller handle 320 by fasteners 302 and 304, which may include any of the fasteners described above. Pouch 300 may include pocket 306 with zipper 308 for enclosing multimedia device 330. Pocket 306 may also include clear window 312 allowing for viewing and interacting with multimedia device 330 through window 312 when secured within pocket 306. Pouch 300 may also include sunshade 310, providing shade for a child seated in stroller seat 322. In one embodiment, pouch 300 may be oriented in an upward-facing, angled position as illustrated in FIG. 3.

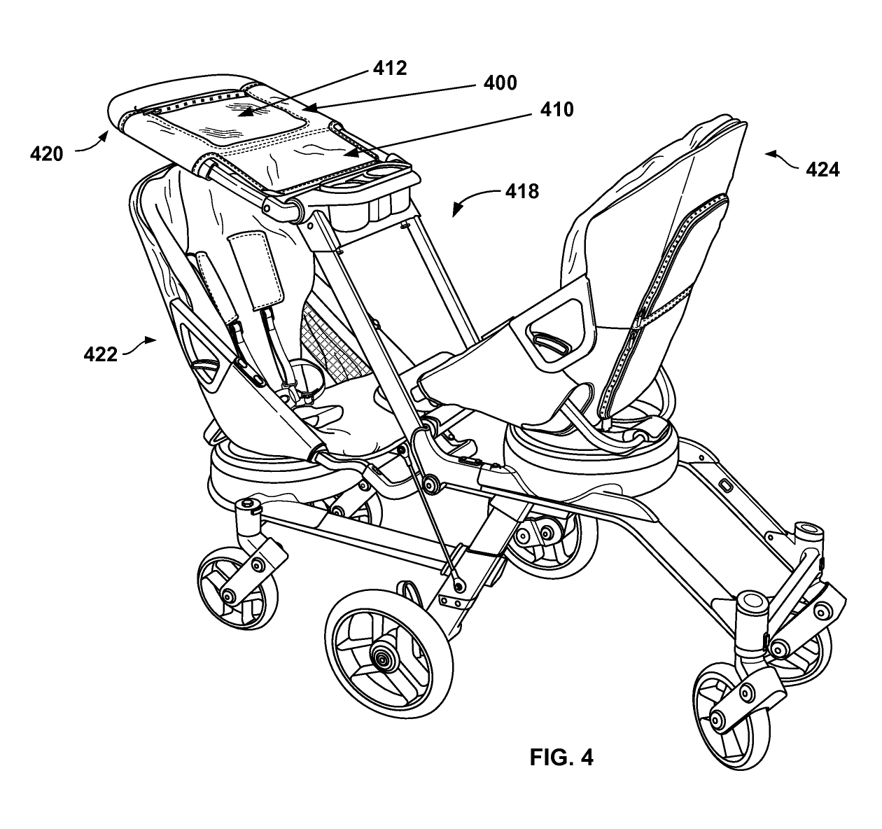

FIG. 4 illustrates two-seated stroller 418 with exemplary multimedia device pouch 400 attached to stroller handle 420. In one embodiment, pouch 400 may be attached to the sides of U-shaped stroller handle 420 such that window 412 is oriented in an upward-facing position, allowing for a multimedia device within pouch 400 to be visible through window 412 to a parent pushing stroller 418. As illustrated, pouch 400 may be configured and attached to stroller 418 to provide shade to a child seated in stroller seat 422. Pouch 400 may also include additional material illustrated as sunshade 410, providing additional protection for a child seated in stroller seat 422. In one embodiment, stroller handle 420 may be pivoted to a different angle so as to make window 412—or the viewing side of pouch 400—visible to a child seated in stroller seat 424. In another embodiment, pouch 400 may be configured and attached such that window 412—or the viewing side of pouch 400—faces downward and is visible to a child seated in stroller seat 422. In addition, extra folds of fabric and/or fasteners may be integrated into pouch 400 to allow pouch 400 to adjust to a variety of different viewing angles in relation to stroller handle 420, thereby adjusting the viewing angle to suit the needs of parents and children of varying heights. Thus, pouch 400 may be configured to attach to stroller handle 420 in multiple orientations, and stroller handle 420 may be configured to pivot, thereby providing a wide variety of viewing orientations for both parents and children.

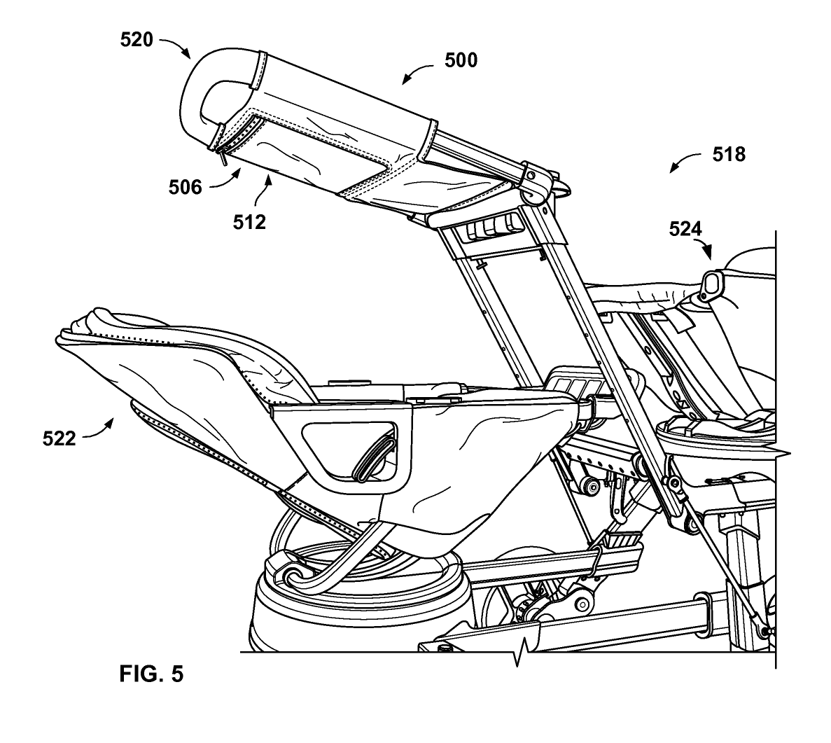

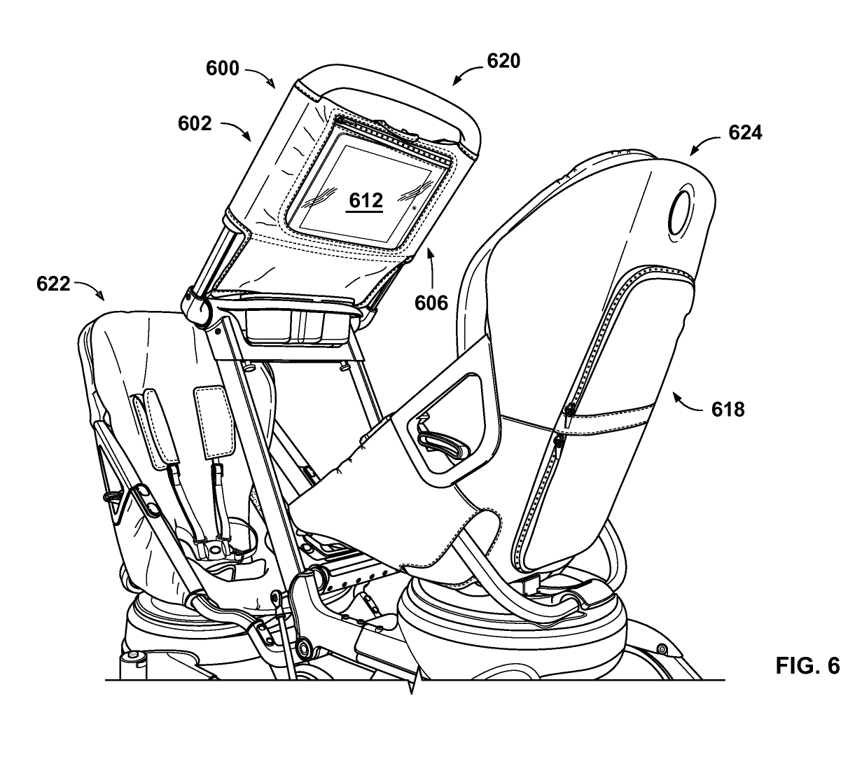

FIG. 5 illustrates stroller 518 with exemplary multimedia device pouch 500 attached to stroller handle 520 and configured in a downward-facing orientation for viewing by a child in a horizontal or reclined position in stroller seat 522. In one embodiment, pouch 500 may be configured and attached to stroller handle 520 such that pocket 506 with window 512 faces downward toward a child traveling in stroller seat 522. Pouch 500 may include additional folds of fabric and fasteners to allow a parent to angle pouch 500 in relation to stroller handle 520 to obtain the optimal viewing angle for a child traveling in stroller seat 522. Beneficially, a parent may then employ multimedia devices held securely in pouch 500 to entertain a child traveling in stroller seat 522, potentially allowing the parent additional time away from home with the child occupied.

FIG. 6 illustrates stroller 618 with exemplary multimedia device pouch 600 attached to stroller handle 620 and configured in a horizontal-facing orientation for viewing by a child in an upright position in stroller seat 624. In one embodiment, pouch 600 may be configured and attached to stroller handle 620 with fastener 602 such that pocket 606 with window 612 faces in a horizontal direction toward a child traveling in stroller seat 624.

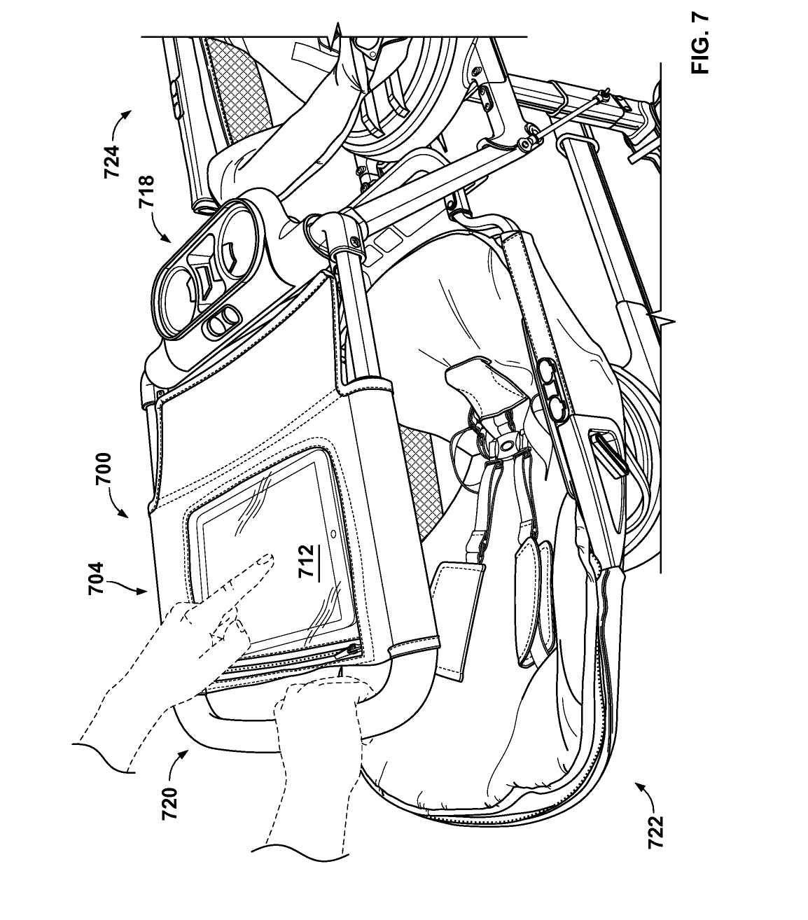

FIG. 7 illustrates stroller 718 with exemplary multimedia device pouch 700 attached to stroller handle 720 and configured in an upward-facing orientation for viewing by a parent pushing stroller 718. Pouch 700 may be attached to stroller handle 720 using fastener 704, which may be any fastener described above. Stroller handle 720 may be pivoted away from stroller seat 724 and above stroller seat 722 such that pouch 700 shades a child seated in stroller seat 722. With pouch 700 attached and oriented with window 712 facing upward, a parent may interact with and view a multimedia device within pouch 700 while pushing stroller 718.

In one embodiment, a stroller handle may be configured to pivot to one or more of the positions illustrated in FIGS. 5-7, and a multimedia device pouch may be configured to attach to the stroller handle in a variety of orientations, thereby providing a variety of viewing orientations to parents and children. For instance, as illustrated in FIG. 5, stroller handle 520 may be pivoted to one side of stroller 518 away from stroller seat 524, and pouch 500 may be attached such that window 512 faces down toward a child seated in stroller seat 522. In a different variation, as illustrated in FIG. 6, stroller handle 620 may be pivoted to a different side of stroller 618 away from child seat 622, and pouch 600 may be attached such that window 612 faces in a horizontal direction toward a child seated in stroller seat 624. In yet another variation, as illustrated in FIG. 7, stroller handle 720 may be pivoted to one side of stroller 718 away from stroller seat 724, and pouch 700 may be attached such that window 712 faces upward toward a parent pushing stroller 718. Thus, multiple viewing orientations are obtainable by configuring a stroller handle to pivot to multiple positions and configuring a multimedia device pouch as described herein to attach to a stroller in multiple orientations.

The foregoing descriptions of specific embodiments have been presented for purposes of illustration and description. They are not intended to be exhaustive, and it should be understood that many modifications and variations are possible in light of the above teaching.

What is claimed is:

1. A stroller comprising:
a child seat;
a handle for pushing the stroller; and
a multimedia device pouch attached to the handle, the pouch comprising:
one or more fasteners for attaching the pouch to the stroller handle; and
a pocket configured to at least partially secure a multimedia device, the pocket comprising a window through which the device may be viewed.

2. The stroller of claim 1, the multimedia device pouch further comprising:
one or more of a zipper, a snap, Velcro, a magnet, elastic, a screw, extra fabric, or a fastener configured to angle the pocket for viewing the multimedia device at two or more viewing angles.

3. The stroller of claim 1, wherein the one or more fasteners are configured to attach the pouch to the stroller handle in two or more viewing orientations.

4. The stroller of claim 1, wherein the handle is configured to be pivoted between a first operating position and a second operating position, and wherein the window of the multimedia device pouch is oriented in a first viewing orientation in the first operating position and in a second viewing orientation in the second operating position.

5. The stroller of claim 4, wherein the one or more fasteners are configured to attach the pouch to the stroller handle in two or more viewing orientations in both the first operating position and the second operating position.

6. The stroller of claim 4, wherein the first viewing orientation is configured for viewing by a user pushing the stroller and the second viewing orientation is configured for viewing by a passenger in the child seat of the stroller.

7. The stroller of claim 4, wherein the one or more fasteners comprise Velcro, a snap, a screw, elastic, or one or more zippers.

8. The stroller of claim 4, wherein the window is configured to allow user interaction with one or more buttons and a touch-sensitive device through the window.

9. The stroller of claim 8, wherein the window comprises polyvinyl chloride (PVC) or ethylene vinyl acetate (EVA).

10. The stroller of claim 4, wherein the window is configured to allow user interaction with one or more buttons and a capacitive touch-sensitive device through the window.

11. The stroller of claim 10, wherein the window comprises polycarbonate (PC) or polyethylene terephthalate (PET).

12. The stroller of claim 4, the pocket comprising a closing mechanism comprising one or more of a zipper, a snap, Velcro, a magnet, elastic, a screw, or a fastener.

13. The stroller of claim 4, the multimedia device pouch further comprising:
material configured to shade a stroller passenger from the sun, wherein the material is configured to extend from the pouch and attach to the stroller.

14. The stroller of claim 4, the multimedia device pouch further comprising:
one or more holes configured to route a wire out of the pocket.

15. The stroller of claim 4, the multimedia device pouch further comprising:
one or more secondary pockets.

16. A multimedia device pouch for attaching to a stroller, the pouch comprising:
one or more fasteners for attaching the pouch to a stroller; and
a pocket configured to at least partially secure a multimedia device, the pocket comprising a window through which the device may be viewed;
wherein the one or more fasteners are configured to attach the pouch to the stroller in two or more viewing orientations.

17. The multimedia device pouch of claim 16 further comprising:
one or more of a zipper, a snap, Velcro, a magnet, elastic, a screw, extra fabric, or a fastener configured to angle the pocket for viewing the multimedia device at two or more viewing angles.

18. The multimedia device pouch of claim 16, wherein the one or more fasteners comprise Velcro, a snap, a screw, elastic, sewn fabric, or one or more zippers.

19. The multimedia device pouch of claim 16, wherein the window is configured to allow user interaction with one or more buttons and a touch-sensitive device through the window.

20. The multimedia device pouch of claim 16, wherein the window is configured to allow user interaction with one or more buttons and a capacitive touch-sensitive device through the window.

21. The multimedia device pouch of claim 16, the pocket comprising a closing mechanism comprising one or more of a zipper, a snap, Velcro, a magnet, elastic, a screw, or a fastener.

22. The multimedia device pouch of claim 16 further comprising:
material configured to shade a stroller passenger from the sun, wherein the material is configured to extend from the pouch and attach to the stroller.

23. The multimedia device pouch of claim 16 further comprising:
one or more holes configured to route a wire out of the pocket.

24. The multimedia device pouch of claim 16 further comprising:
one or more secondary pockets.
